(19) United States
(12) Patent Application Publication
(10) Pub. No.: US 2006/0197978 A1
(43) Pub. Date: Sep. 7, 2006

(54) Image processing apparatus and image processing method

(75) Inventor: Hiroaki Kishimoto, Warabi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/360,474

(22) Filed: Feb. 24, 2006

(30) Foreign Application Priority Data
Mar. 3, 2005 (JP) 2005-059364
Feb. 14, 2006 (JP) 2005-037255

(51) Int. Cl. G06F 3/12

(52) U.S. Cl. 358/1.15

(57) ABSTRACT

Provided herein are an image processing apparatus and an image processing method which can prevent erroneous charging for a charge-free printing job even in a case where the charge-free printing job has interrupted execution of a charged printing job which requires charge processing. According to the image processing apparatus, a first job is generated for copying and outputting, at cost, image data or the like inputted by reading an original document, then charging is performed. Under the condition that charging is performed, the first job is executed and the image data is copied. If there is a reason of job suspend in this stage and a second job which is to be outputted at no cost is generated, the second job is executed prior to execution of the first job without charging processing for the second job.

### FIELD OF THE INVENTION

The present invention relates to an image processing apparatus such as a digital multi-function apparatus which executes charged jobs and charge-free jobs, and an image processing method.

### BACKGROUND OF THE INVENTION

Recent years have seen prevailing utilization of a digital multi-function apparatus having scanner and printer functions for being connected with a network such as the Internet, LAN and the like. Utilization of such digital multi-function apparatus is not limited to just offices, but also is moving into public space such as convenience stores and schools. To collect fees for actual copying and printing execution directly from users, generally a digital multi-function apparatus placed in public space comprises a charging device which charges fees for copying and printing execution. For instance, Japanese Patent Application Laid-Open No. 2003-244349 discloses such technique.

Meanwhile, the aforementioned digital multi-function apparatus often comprises a report printing function. This function prints out internal status data and setting contents of the digital multi-function apparatus in response to an operation of a service person who performs maintenance of the apparatus or an administrator who is in charge of the apparatus. Even during execution of a charged job by a general user, if there is a reason of suspend such as paper jam, report printing may be carried out while interrupting the job.

However, if an administrator or a service person carelessly designates report printing while a digital multi-function apparatus is executing a charged copying job or printing job paid by a general user as described above, the following problem can occur. More specifically, the fee for report printing, which is not requested by the user and supposed to be printed for free, may erroneously be withdrawn from the money put in by the user for the suspended job.

In a case such problem occurs, the fee that has erroneously been withdrawn from the money put in by the user for the charged copying job must be returned to the user. To return money to the user for the erroneously withdrawn fee, in case of collecting copy charges by cash, it is necessary to add to the charging device a mechanism for returning money for the erroneously withdrawn fee.

Furthermore, the charging device incorporated in the digital multi-function apparatus handles not only cash, but also withdraw fees by utilizing digital money, prepaid card or the like. In a case of such charging system, it is impossible to simply add to the charging device, like cash, a mechanism for returning money for the erroneously withdrawn fee, and extremely complicated processing is necessary.

### SUMMARY OF THE INVENTION

The present invention has been proposed in view of the above-described problem. The object of the present invention is to provide an image processing apparatus and an image processing method which can prevent erroneous charging for a charge-free printing job even in a case where the charge-free printing job has interrupted execution of a charged printing job which requires charge processing.

In order to solve the above-described problem, an image processing apparatus according to the present invention comprises:

an input unit adapted to input image data;

a charging unit adapted to charge for a job;

a first execution unit adapted to execute a first job for outputting the image data with charge under a condition that charging is performed; and

a second execution unit adapted to, in a case where execution of the first job is suspended, execute a second job at no cost prior to execution of the first job without charging.

Furthermore, in the aforementioned image processing apparatus according to the present invention, wherein after execution of the second job by the second execution unit is completed, said first execution unit resumes execution of the first job.

Furthermore, in the aforementioned image processing apparatus according to the present invention, wherein said second execution unit executes the second job while execution of the first job by the first execution unit is suspended.

Furthermore, in the aforementioned image processing apparatus according to the present invention, wherein in a case where execution of the first job is suspended based on an operator's designation, said second execution unit executes the second job.

Furthermore, in the aforementioned image processing apparatus according to the present invention, wherein in a case where execution of the first job is suspended based on paper jam, said second execution unit executes the second job.

Furthermore, in the aforementioned image processing apparatus according to the present invention, wherein after the paper jam is resolved, said second execution unit executes the second job.

Furthermore, in the aforementioned image processing apparatus according to the present invention, wherein in a case where charging by said charging unit is not performed and execution of the first job is suspended, said second execution unit executes the second job.

Furthermore, in the aforementioned image processing apparatus according to the present invention, wherein the second job is a job related to report printing.

Furthermore, in the aforementioned image processing apparatus according to the present invention, wherein the first job is a copying job for copying on a printing medium the image data inputted by reading an original document by said input unit and outputting the printing medium, or a printing job for printing on a printing medium the image data inputted by said input unit and outputting the printing medium.

Furthermore, in order to solve the above-described problem, an image processing apparatus according to the present invention comprises:

an input unit adapted to input image data;

a charging unit adapted to charge for a job;

a first execution unit adapted to execute a first job for outputting the image data with charge under a condition that charging is performed; and

a second execution unit adapted to, in a case where charging for the first job by said charging unit is suspended, execute a second job at no cost prior to execution of the first job.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a construction of a printing system comprising a digital multi-function apparatus 100 according to an embodiment of the present invention;

FIG. 2 is an external view of the digital multi-function apparatus 100 according to the embodiment of the present invention; and

FIG. 3 is a flowchart describing a charging procedure that accompanies copying job execution of the digital multi-function apparatus 100 according to the embodiment of the present invention.

### DETAILED DESCRIPTION OF THE PREFERRED EMBODIMENT

Hereinafter, an image processing method of a digital multi-function apparatus, which serves as an image processing apparatus according to an embodiment of the present invention, is described in detail with reference to the drawings.

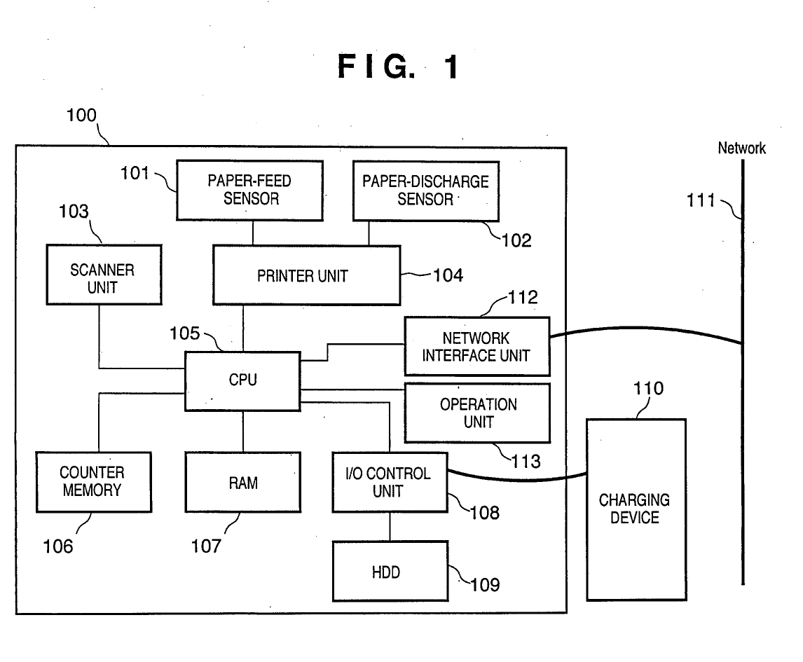

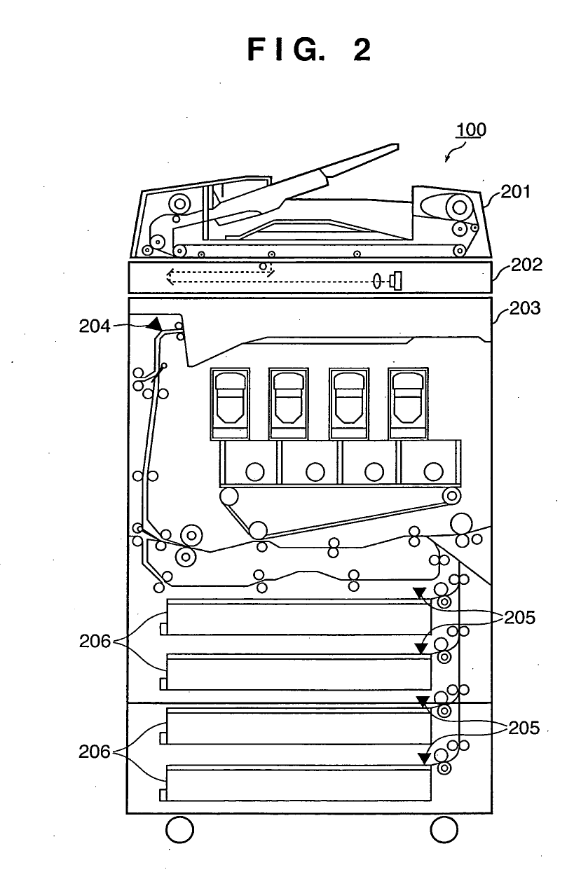

FIG. 1 is a block diagram showing a construction of a printing system comprising a digital multi-function apparatus 100 according to the embodiment of the present invention. As shown in FIG. 2, the printing system according to the present embodiment comprises the digital multi-function apparatus 100 capable of data communication with other apparatuses through a network 111, and a charging device 110 connected to the apparatus 100 for charging printing job fees or the like.

As shown in FIG. 1, the digital multi-function apparatus 100 comprises a printer unit 104 which performs image data printing by being connected to a paper-feed sensor 101 and a paper-discharge sensor 102, and a scanner unit 103 which generates image data by reading an original document. The digital multi-function apparatus 100 further comprises a network interface unit 112 for being connected to the network 111, and an operation unit 113 for executing a user operation. The digital multi-function apparatus 100 further comprises an I/O control unit 108 which controls data input/output processing between the charging device 110 provided to perform charging and a hard disk (HDD) 109 provided to store programs or the like. The digital multi-function apparatus 100 further comprises RAM 107 capable of developing a program or the like, and a counter memory 106 for counting the number of print sheets (printing medium) being printed. Each of these units is controlled by a CPU 105.

FIG. 2 is an external view of the digital multi-function apparatus 100 according to the embodiment of the present invention. As shown in FIG. 2, the digital multi-function apparatus 100 comprises a document feeder unit 201 for feeding an original document, and a scanner unit 202 for reading the original document. The digital multi-function apparatus 100 further comprises a printer unit 203 for printing out an image, a paper-feed cassette 206 for storing paper to be fed upon printing, a paper-discharge sensor 204 for detecting a paper discharge, and a paper-feed sensor 205 for detecting a paper feed.

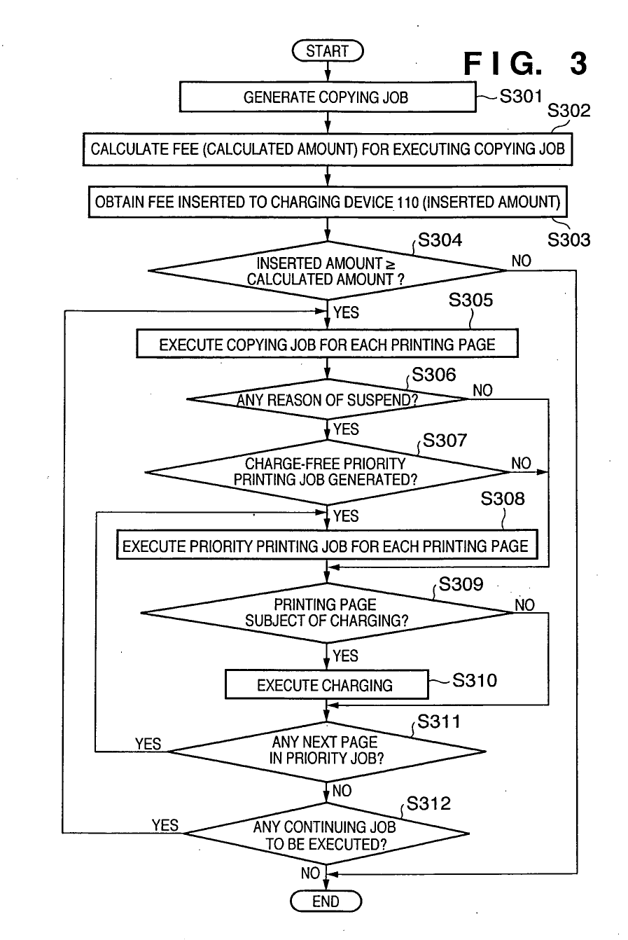

FIG. 3 is a flowchart describing a charging procedure that accompanies copying job execution of the digital multi-function apparatus 100 according to the embodiment of the present invention. Although the following embodiment describes processing of the digital multi-function apparatus 100 taking a copying job as an example, the similar output operation and charging operation can be performed in a case of a printing job of digital contents. Furthermore, the following operation is executed under the control of the CPU 105 by developing a processing program stored in the hard disk 109 or the like in the RAM 107.

The program executed by the CPU 105 starts an original document copying process in response to a user's operation on the operation unit 113. First, the user who performs copying of an original document using the digital multi-function apparatus 100 places the document on the scanner unit 103 to have the scanner read the document. This operation causes image data generation in the digital multi-function apparatus 100, and causes copying job generation for copying and outputting the image data (step S301). Next, the digital multi-function apparatus 100 calculates a fee (calculated amount) to be paid by the user in compensation for executing the generated copying job (step S302).

Next, the digital multi-function apparatus 100 calculates the amount of money (inserted amount) inserted by the user in the charging device 110 based on the cash put in by the user or the remaining amount of a prepaid card, and collects the amount from the charging device 110 (step S303). Then, the calculated amount obtained in step S302 is compared with the inserted amount obtained in step S303 (step S304). As a result, if the calculated amount is larger than the inserted amount (NO), the copying job designated by the user is not executed due to short paid. In other words, the image data generated from the read original document is not copied, and the process ends.

Note that in a case where the calculated amount is larger than the inserted amount (NO) in step S304, the following processing may be performed instead of terminating the process as described above. More specifically, the user is asked to insert the short fee in the charging device 110. When further insertion of cash or a prepaid card or the like in the charging device 110 is detected, the inserted amount put in by the user is acquired and compared again with the calculated amount. In other words, step S303 is executed again after returning to step S304. Moreover, the user may in advance insert the fee in the charging device 110 prior to starting the copying process described in the flowchart, or the user may insert the fee after the copying job fee is calculated in step S302.

Meanwhile, if the inserted amount is larger than the calculated amount (YES) in step S304, the copying job generated in step S301 is executed for the number of copies in units of printing page (in units of 1 page) (step S305). Next in step S306, it is determined whether or not there is a reason to suspend the copying job. Herein, the reason to suspend the copying job is a case where the copying job is temporarily suspended due to paper out or paper jam in the digital multi-function apparatus 100 (e.g., feeding-paper jam or discharging-paper jam) or due to a user's termination operation. In addition, the reason of suspend includes a case where the remains of inserted amount become 0 or short. If there is no reason of suspend in step S306 (No), the control proceeds to step S309. If there is a reason of suspend in step S306 (Yes), then in step S307, it is detected whether or not a charge-free printing job, such as report printing on the status of the digital multi-function apparatus 100, has been generated. The report printing is a function for printing out results of printing jobs or various setting contents of the digital multi-function apparatus 100. The report printing is mainly performed in accordance with a designation of a service person who performs maintenance of the apparatus 100 or an administrator of the apparatus 100. The report printing function is provided for printing out a charge-free priority job, which is outputted preferentially to a charged copying job upon priority-output designation even during an execution of a charged copying job.

Note in step S306, if the copying job is suspended because the remains of the inserted-amount are short, the copying-job output cannot be continued unless the user inserts an additional fee. However, a charge-free printing job can be executed as long as there is no error in the printing unit of the digital multi-function apparatus 100, e.g., paper out or toner exhaustion. Therefore, in this case, even though the report-printing designation is not a priority designation to a charged copying job, the report printing job may be executed first. In other words, in this case, a charge-free report printing job is handled as a priority job to a charged copying job regardless of existence or absence of a priority designation.

By virtue of the above processing, termination of a printing job caused by factors other than the printing unit does not obstruct execution of other executable printing jobs. Therefore, performance of the printing job can be improved.

The present embodiment describes as an example a case where an occurrence of paper jam detected by the paper-feed sensor 101 or paper-discharge sensor 102 causes temporary termination (suspend) of a user's copying job. Note, as mentioned above, the cause for temporary termination of a copying job is not limited to paper jam only.

In step S307, in a case where generation of a job for preferentially executing charge-free report printing is detected (YES), the priority job is executed to perform report printing in units of printing page (in units of page) (step S308). Note that after the copying job is temporarily terminated due to the occurrence of paper jam, processing for resolving paper jam is performed before starting the charge-free report printing in step S308 to return the state of the digital multi-function apparatus 100 to normal. After the report printing is performed, it is determined whether or not the report printing is a subject of charging (step S309). Since the priority job executed in step S308 is charge free (NO), the control proceeds to step. S311. In step S311, it is determined whether or not there is a next page (next printing page) to be printed in the priority job. If there is a next page (YES), the control returns to step S308. If there is no next page to be printed in the priority job in step S311 (NO), the priority job printing ends and the control proceeds to step S312 for determining whether or not there is a continuing job (copying job).

The above-described processing is performed while the copying job generated in step S301 and being executed is temporarily terminated. Although the charge-free priority job has interrupted the copying job and is executed in step S308, the copying job generated in step S301 is still continuing (YES in step S312). Therefore, the control returns to step S305, automatically resuming the copying job. To simplify the description, the present embodiment assumes that the copying job automatically resumes. However, the copying job may resume upon user's resumption operation. Note that if the reason of suspend in step S306 is a shortage of inserted amount, the user's resumption operation includes insertion of additional money.

Then in step S307, existence or absence of a priority job is determined as mentioned above. As a result, if there is no reason of suspend and no priority job is generated (NO), the copying job execution continues. After the job is executed, whether or not the copying job is a subject of charging is determined (step S309). Also, as mentioned above, in a case where there is no reason of suspend in step S306 (NO), the control proceeds to step S309.

As a result, if it is determined that the printing page of the current copying job should be charged (YES), the fee for the printing page is charged (step S310). Herein, an example of charging (step S310) according to the present embodiment is given. The digital multi-function apparatus 100 first collects a fee for the current printing page, transmits a paper-feed signal of the printing page to the charging device 110, and then transmits a paper-discharge signal to the charging device 110. The apparatus 100 causes the charging device 110 to withdraw the copying fee for each printing page. Note that the paper-feed signal and the paper-discharge signal transmitted to the charging device 110 may include information regarding the fee of the printing page, or information such as paper size or color data of the printing page that can lead to the printing fee. Thereafter, this processing is repeated until execution of the copying job is completed.

Note that although the printing system shown in FIG. 2 is configured by directly connecting the charging device 110 with the I/O control unit 108 of the digital multi-function apparatus 100 via a connection cable, other configuration may be adopted. For instance, a relay controller of paper-feed signals and paper-discharge signals may be provided between the I/O control unit 108 and the charging device 110, and the I/O control unit 108 and the charging device 110 may be connected via the relay controller. The relay controller may receive paper-feed signals and paper-discharge signals from the digital multi-function apparatus 100 and transmit the signals to the charging device 110. Furthermore, the relay controller may be connected to the digital multi-function apparatus 100 via the network interface 112 and the network 111.

The embodiment of the present invention has been described above. The present invention can be implemented in the form of, e.g., a system, an apparatus, a method, a program, or a storage medium (recording medium). More specifically, the present invention may be applied to a system constituted by a plurality of devices or to a stand-alone apparatus.

Note that the present invention includes a case of directly or remotely supplying a system or apparatus with a software program realizing the above-described functions of the present embodiment, then reading and executing the supplied program codes by a computer of the system or apparatus. The program corresponds to the flowchart in the drawing described in the above embodiment.

Therefore, to realize the functions of the present invention by a computer, the program codes themselves installed in the computer also constitute the present invention. In other words, the present invention includes the computer program that realizes the functions of the present invention.

In this case, it may be in the form of object codes, a program executed by an interpreter, or script data supplied to an operating system (OS), as long as it functions as a program.

For a recording medium supplying the program, for instance, a floppy (registered trademark) disk, a hard disk, an optical disk, a magneto-optical disk, MO, CD-ROM, CD-R, CD-RW and the like may be used. Furthermore, for a recording medium, a magnetic tape, a non-volatile type memory card, ROM, DVD (DVD-ROM, DVD-R) and the like can be used.

Besides the above, the program may be downloaded from a homepage on the Internet using a browser of a client computer. A computer program itself according to the present invention or a compressed file including an automatic installation function may be downloaded from a homepage to a recording medium such as a hard disk. Alternatively, program codes constituting the program according to the present invention may be divided into plural files, and each of the plural files may be downloaded from different home pages to realize the present invention. In other words, the present invention includes a WWW server which allows plural users to download the program file for realizing the functions of the present invention on a computer.

Moreover, the program according to the present invention may be enciphered, stored in a storage medium such as CD-ROM, and distributed to users. In this case, only a user who satisfies a predetermined condition may be allowed to download key data for deciphering the program from a homepage on the Internet and execute the program deciphered by the key data for installation in the computer.

Furthermore, the above-described functions of the embodiment may be realized by executing the program read by a computer. The above-described functions of the embodiment may also be realized in a case where an OS (operating system) or the like working on the computer performs part or the entire processes in accordance with designations of the program codes.

Furthermore, the program read from the recording medium may be written in a function expansion card which is inserted into the computer or in a memory provided in a function expansion unit which is connected to the computer. A CPU or the like contained in the function expansion card or unit may perform part or the entire processes in accordance with designations of the program codes. The above-described functions of the embodiment are also realized by this processing.

According to the present invention, even in a case where a charge-free printing job has interrupted execution of a charged printing job which requires charge processing, it is possible to prevent erroneous charging for the charge-free printing job.

The present invention is not limited to the above embodiment and various changes and modifications can be made within the spirit and scope of the present invention. Therefore, to apprise the public of the scope of the present invention, the following claims are made.

This application claims the benefit of Japanese Application Nos. 2005-059364 filed Mar. 3, 2005, and 2006-037255 filed Feb. 14, 2006 which are hereby incorporated by reference herein in their entirety.

What is claimed is:

1. An image processing apparatus comprising:
an input unit adapted to input image data;
a charging unit adapted to charge for a job:
a first execution unit adapted to execute a first job for outputting the image data with charge under a condition that charging is performed; and
a second execution unit adapted to, in a case where execution of the first job is suspended, execute a second job at no cost prior to execution of the first job without charging.

2. The image processing apparatus according to claim 1, wherein after execution of the second job by the second execution unit is completed, said first execution unit resumes execution of the first job.

3. The image processing apparatus according to claim 1, wherein said second execution unit executes the second job while execution of the first job by the first execution unit is suspended.

4. The image processing apparatus according to claim 1, wherein in a case where execution of the first job is suspended based on an operator's designation, said second execution unit executes the second job.

5. The image processing apparatus according to claim 1, wherein in a case where execution of the first job is suspended based on paper jam, said second execution unit executes the second job.

6. The image processing apparatus according to claim 5, wherein after the paper jam is resolved, said second execution unit executes the second job.

7. The image processing apparatus according to claim 1, wherein in a case where charging by said charging unit is not performed and execution of the first job is suspended, said second execution unit executes the second job.

8. The image processing apparatus according to claim 1, wherein the second job is a job related to report printing.

9. The image processing apparatus according to claim 1, wherein the first job is a copying job for copying on a printing medium the image data inputted by reading an original document by said input unit and outputting the printing medium, or a printing job for printing on a printing medium the image data inputted by said input unit and outputting the printing medium.

10. An image processing apparatus comprising:
an input unit adapted to input image data;
a charging unit adapted to charge for a job;
a first execution unit adapted to execute a first job for outputting the image data with charge under a condition that charging is performed; and
a second execution unit adapted to, in a case where charging for the first job by said charging unit is suspended, execute a second job at no cost prior to execution of the first job.

11. An image processing method comprising:
an input step of inputting image data to an image processing apparatus;
a charging step of charging for a job;
a first execution step of executing a first job for outputting the image data with charge under a condition that charging is performed; and
a second execution step of, in a case where execution of the first job is suspended, executing a second job at no cost prior to execution of the first job without charging.

12. An image processing method comprising:
an input step of inputting image data to an image processing apparatus;
a charging-step of charging for a job;
a first execution step of executing a first job for outputting the image data with charge under a condition that charging is performed; and
a second execution step of, in a case where charging for the first job in said charging step is suspended, executing a second job at no cost prior to execution of the first job.

13. A program which causes a computer to execute:
an input procedure of inputting image data;
a charging procedure of charging for a job;
a first execution procedure of executing a first job for outputting the image data with charge under a condition that charging is performed; and
a second execution procedure of, in a case where execution of the first job is suspended, executing a second job at no cost prior to execution of the first job without charging.

14. A program which causes a computer to execute:
an input procedure of inputting image data;
a charging procedure of charging for a job;
a first execution procedure of executing a first job for outputting the image data with charge under a condition that charging is performed; and
a second execution procedure of, in a case where charging for the first job in said charging procedure is suspended, executing a second job at no cost prior to execution of the first job.

15. A computer-readable storage medium storing the program described in claim 13.

16. A computer-readable storage medium storing the program described in claim 14.
